(19) United States
(12) Patent Application Publication
(10) Pub. No.: US 2012/0232948 A1
(43) Pub. Date: Sep. 13, 2012

(54) INFORMATION TECHNOLOGY INFRASTRUCTURE RISK MODELING

(76) Inventors: Kay WOLF, Bonn NRW (DE); Stefan Sahling, Flonheim (Uffhofen) RP (DE)

(21) Appl. No.: 13/042,166

(22) Filed: Mar. 7, 2011

(51) Int. Cl. G06Q 10/00

(52) U.S. Cl. 705/7.28

(57) ABSTRACT

A system, method, and non-transitory computer readable medium for modeling IT infrastructure risk factors. The non-transitory computer readable medium having stored instructions, which when executed by a processor may cause the processor to generate a plurality of risk matrices, where an external process of a customer of an IT supplier is mapped to an IT infrastructure element of the IT supplier and a business process of a client of the customer is mapped to the external process of the customer, perform a risk analysis using the plurality of matrices to determine a criticality value for the IT infrastructure element in relation to the business process, and cause a presentation of the criticality value.

### BACKGROUND

Identifying risks and providing risk management solutions to businesses using or providing information technology (IT) infrastructure systems has posed challenges, in part because of the complex nature of IT infrastructure systems and in part because of the different entities involved in providing and accessing such systems. An enterprise relying on or providing elements for an IT infrastructure system may face business and other risks that may not be directly within the enterprise's control. Sound management of such risks may be important to the survival of the enterprise.

Risk management pertains to tasks for identifying, assessing and prioritizing risks that may occur to an organization, a process or a system (such as an IT infrastructure system) and also to tasks undertaken to minimize, monitor, and/or control probabilities for (or the impact of) unfortunate events (and/or maximize opportunities in the face of such risks). Risks concerning IT infrastructure systems are complex, because IT spans a wide variety of technology that includes, for example, computer hardware, computer software, programming languages, protocols and data constructs. Broadly speaking, any element used to provide data via a computer-based distribution system can be considered part of IT.

IT infrastructure, for example in a distributed computing system like an Internet-based system, may include the physical hardware that connects the computers and users (for example, the transmission media, including telephone lines, cable lines, satellites antennas, routers, networks, switches and the other transmission/connection equipment providing transmission paths). Infrastructure may also include the software, data and protocols used to send, receive, and manage the transmitted data.

Assessing and managing risk for an enterprise concerning its ties to an IT infrastructure (either as a provider or a user) and the business processes, products and services that depend on the IT infrastructure creates challenges, because of the many possible kinds of hardware and software systems involved and also because of the number of different actors that operate in such systems. IT service suppliers (such as server solution providers, firewall and/or security system providers) and access suppliers (such as cable, telephone, satellite access and other such network or access-providing companies) provide IT infrastructure and communication channel access to customers, such as business entities wishing to exchange data with and provide products and services to their clients. The customers use such provided IT access equipment and services to create communications channels to their clients (for providing goods and services). In addition to the IT service provider's equipment and access, customers and clients may each also have their own internal IT infrastructures which may be used for customer and client communications.

In systems involving different actors such as IT infrastructure suppliers, customers and clients, it may be difficult for a customer of an IT service supplier, a client of a customer (or even an IT service supplier) to identify risks and execute programs of risk management concerning the IT infrastructure system (or the processes, products and services related thereto). For example, it may be difficult for the customer, client or the IT supplier to obtain end-to-end (E2E) information regarding an enterprise business processes, because that information may not be fully documented across the acting entities (IT service supplier, customer and client) and/or may be only partially captured by each individual entity. Other activities such as incident management (determining the causes and solutions system failures), change management (effectively managing system replacements and planned outages), and procedure management (such as determining adequate levels of service in a service level agreement (SLA)) can also be problematic where in an IT infrastructure, equipment, processes and actors can be many and interdependent.

### BRIEF DESCRIPTION OF THE DRAWINGS

FIG. 1 illustrates a system for identifying, analyzing and managing risks, according to an embodiment of the present invention;

FIG. 2 illustrates a data environment, in accordance with an embodiment of the invention;

FIG. 3 illustrates representative data inputs for a common factors data repository and specific factors data repository, in accordance with an embodiment of the invention;

FIG. 4 illustrates risk matrixes in accordance with an embodiment of the invention;

FIG. 5A illustrates dependencies among risk matrixes in accordance with an embodiment of the invention;

FIG. 5B illustrates third party vendor dependencies in accordance with an embodiment of the invention;

FIG. 6 illustrates a report in accordance with an embodiment of the invention;

FIGS. 7A-7B illustrate a process in accordance with an embodiment of the invention;

FIG. 8A illustrates a system in accordance with an embodiment of the invention;

FIG. 8B illustrates another example of a system in accordance with an embodiment of the invention; and

FIG. 9 illustrates information aggregation in accordance with an embodiment of the invention.

### DETAILED DESCRIPTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

An embodiment of the present invention may provide a method, system and data storage medium for identifying, analyzing and managing risks by modeling risk factors for enterprises accessing or providing IT infrastructure systems. Such enterprises may include a provider of IT infrastructure services or equipment (an IT supplier), a customer of an IT supplier (a customer), a client of the customer (a client).

Modeling risk factors for elements of an IT infrastructure, may involve mapping, dependencies found between the IT infrastructure elements and the business or enterprise processes using the IT infrastructure elements. For an IT supplier, customer and client, mapping may result in a plurality of risk matrices, where, for example, an external process of the customer may be mapped to an IT infrastructure element of the IT supplier and a business process of a client of the customer may be mapped to the external process of the customer. Identifying, analyzing and managing risks may involve performing a risk analysis, to determine, for example, criticality values for IT infrastructure elements, and providing such the criticality values in reports or on a display. Additionally, third party vendors may also contribute hardware, software, and other resources to the IT infrastructure system (resources which may, for example, be used by the IT supplier, customer or client) and risks from such third party element may also be assessed.

To execute identification, analysis and management of risk concerning an IT infrastructure system and its use, an embodiment of the present invention may provide a risk modeling engine. The risk modeling engine may evaluate and predict the impact that may occur to a business, business process, or IT infrastructure element due to one or more of a multitude of risks factors concerning the IT infrastructure. Risk factors may include technology and innovation risks, operational risk, political/regulatory risks, process risks, and/or human resource/organizational risks.

The risk modeling engine may receive data and may provide evaluations and predictions regarding the sustainability of the IT infrastructure (its hardware, software and/or other elements) or the entities or processes using, or reliant on, the IT infrastructure system. For example, the risk management engine may determine a risk factor value for each component or element of the IT infrastructure, where, for example, a high risk factor value may indicate that the IT infrastructure as a whole, or portion thereof, could be at a greater risk of failure should that component or element fail. The criticality of an IT infrastructure element (sub-system or system) to a business process or business entity may also be assessed with a determined criticality value. The risk modeling engine may include elements such as a risk evaluation unit (or module) or a risk prediction unit (or module). The risk modeling engine may include a controller, processor, and/or central processing unit. In another example, the risk modeling engine may include software modules (e.g. for risk evaluation and risk prediction), which may be executed by a processor.

One source of data for the risk modeling engine may be a configuration management database (CMDB). A CMDB may be an information repository housing data related to components of an IT information system. A CMDB may be maintained, for example, by the IT supplier, the customer and/or the third party vendor. A CMDB, for example, may be compliant with the guidelines and practices set out in Information Technology Infrastructure Library (ITIL) guidelines, known in the IT industry. A CMDB, when following ITIL guidelines, may represent the authorized configuration of the significant components of IT infrastructure system. Information from a CMDB may provide one source of information for the risk modeling engine. Other information sources may include repositories for service level agreement (SLA) information (e.g. providing service level agreement contract term information), business process data for customers and/or clients (e.g. providing business-to-business information regarding suppliers, sales parts, credits, etc), common factor information (providing, for example, statistical data on the system, or parts thereof, such as the number of outages in the system or the number of clients using the system) and specific factor information (providing, for example, data on specific elements, such as the number of firewall rules applying to a specific firewall system, or the number of routing protocols used by a particular router).

Many different data sources can be used as a repository. In an example where an IT supplier is a server system provider, for example, data repositories may include databases (data stores) following the format of a mean-time-to-repair (MTTR), mean-time-to-failure (MTTF) and/mean-time-between-failure (MTBF) data stores of a monitoring system such as the HP Openview Service Desk of the Hewlett-Packard Company of Palo Alto, Calif.

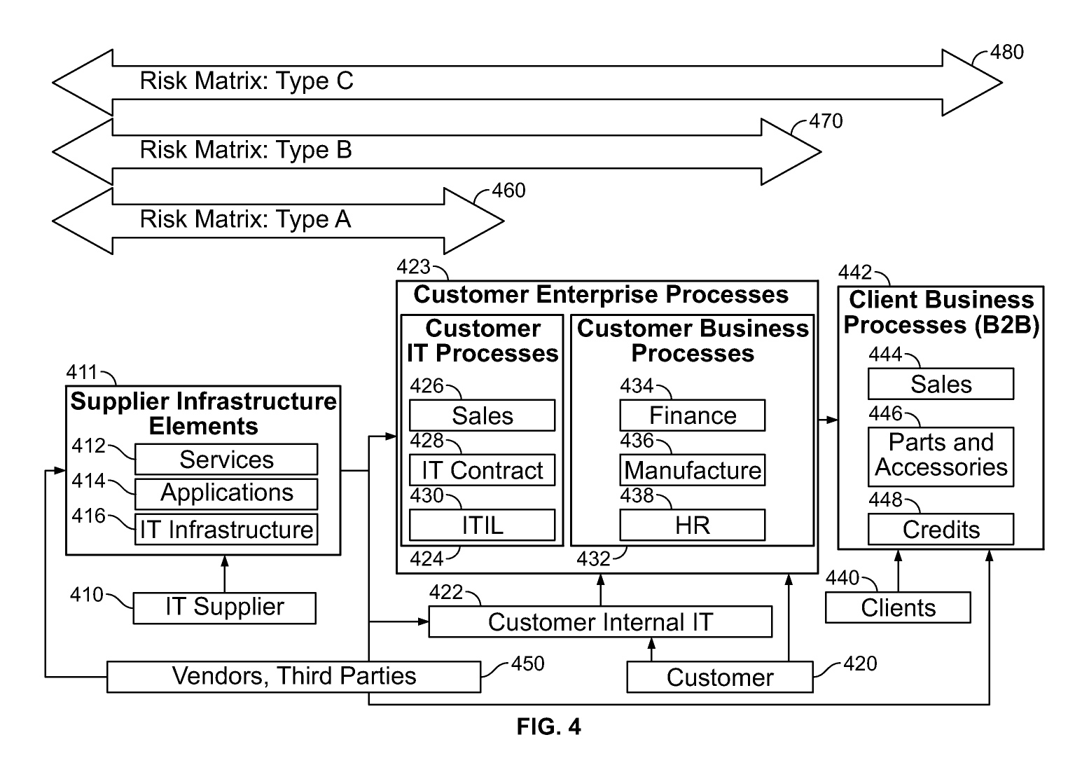

Using the data sources (e.g. a CMDB and SLA, business factor, and common and specific factors repositories), the risk modeling engine may build one or more matrices (e.g. of dependency relationships) in order to identify, analyze and manage risks (see, e.g. FIG. 4). In an example involving a IT service supplier, a customer and a client, the risk modeling engine may generate three different matrices, for example, such as:

A Type A matrix, where IT supplier infrastructure elements and services may be mapped (e.g. linked through dependency relationships) to a customer's internal IT and support processes. Applications provided by an IT supplier such as, mail system, database, and data service applications, may also be mapped to specific IT infrastructure hardware items (like servers, routers, switches, firewalls, cabling, etc.) and to other IT supplier-related applications;

A Type B matrix, where a customer's enterprise processes (e.g. the enterprise processes of the customer's business) may be mapped to IT infrastructure elements provided by the IT supplier or to IT infrastructure elements of the customer's own internal IT departments; and

A Type C matrix, where the business processes of a customer's client may be mapped to the enterprise processes of the customer (and to IT infrastructure elements provided by the IT supplier and/or IT infrastructure elements of the customer's own internal IT departments). In matrix type C, the business processes of the client may include business-to-business (B2B) processes. For example, where a client is an automobile seller, B2B processes may include processes, such as Car Sales, Parts Sales, Accounts, Credits and other automobile-sale-related processes. Client business processes in such an example may map (e.g. through dependency relationships) to customer enterprise processes such as Customer IT systems, Customer finance, Customer manufacturing, etc.

In addition, interdependencies may be considered by the risk modeling engine with regard to third party vendors of IT systems, services or equipment through additional dependencies in the matrices.

Using the constructed matrix (or matrices), the risk modeling engine may evaluate, analyze, and/or correlate the dependencies and or interdependencies shown in the matrices. Outcomes of the risk analysis may include:

Identification of a level of protection a business process or IT infrastructure element may require based upon the process or element's determined business criticality and value (where risk assessment values, e.g. risk factor values, and criticality values, for components, subsystems and systems may be provided);

Identification of the IT infrastructure and design used to implement a business process being analyzed (for example including any manual processes connecting or impacting either the IT infrastructure system or business process using the IT infrastructure system);

Evaluation (e.g. after identifying the IT infrastructure that supports the business process) of potential and/or possible IT infrastructure system failures that may impinge on the performance of the business process or related IT infrastructure elements;

Identification and implementation of proactive measures to reduce the risk associated with the current implementation of a business process in the present IT infrastructure system (for example, by providing recommendations for changes to IT infrastructure, applications, and system design, providing recommendations for recovery strategies);

Provision of recommendations on alternatives—for example recommendations for new or revised terms in IT infrastructure-related agreements, such as service-level agreements (SLAB); recommendations for client contract negotiations (B2B2C) (e.g. between a customer and client); and support of IT incident-, problem-, and/or change-management functions; and

Provision of financial data concerning IT infrastructure system elements, for example, for use as selection criteria in determining an appropriate level of investment into additional and/or upgraded IT infrastructure.

Reports may be generated from the risk modeling engine regarding infrastructure business processing reliability, economic impact statements, etc. Graphical outputs depicting dependencies between the IT infrastructure, the business processes, and the dependencies between the business and its clients may also be provided.

After analysis, the risk modeling engine may provide further proactive assistance, such as by updating a CMDB for the IT infrastructure system (or portion thereof) with risk data infrastructure data components that may allow re-configuration of the IT elements for better management.

An embodiment in accordance with the present invention may provide advantages, for example, in terms of increased availability of applications and services in the IT infrastructure system (like zero outages). Where risks may be identified ahead of time, the availability of applications (e.g. from the IT supplier and used by customers and clients) can be enhanced. An embodiment in accordance with the present invention may also reduce the risk of liability and/or penalties (for example for an IT supplier or a customer), because risks can be identified ahead of a disaster. An embodiment in accordance with the present invention may further increase transparency to the customer (e.g. of the services provided by the IT supplier), better identify areas of responsibility between IT supplier, customer and/or client for assuming risk, and may provide for better management in times of a reduction of services (provisioning). Additionally, an embodiment in accordance with the present invention may reduce costs for ITIL guideline processes, such as: change management (e.g. by reducing user acceptance testing (UAT) costs through clearer definition of rights to such tests and the scope of the tests); incident management; and SLA management (e.g. by defining adequate service levels according to identified risks).

In presently known systems, full risk assessment and analysis of an enterprise's information technology (IT) structure and/or system currently may not be possible, because end-to-end (E2E) information regarding the business's processes to the IT infrastructure may not be fully documented. Missing or incomplete information regarding which of an enterprise's clients depend on the enterprise's processes, applications, and/or services supported by the enterprise's IT structure can limit the accuracy or even feasibility of a risk assessment. Because adequate E2E information regarding business processes (and their requirements) may be lacking, unsuitable service level agreements (SLAs) may be defined and entered into. The service levels set for external IT services, for example, may not sufficiently match the requirements for the business processes of the client or the customer.

In presently known systems, inadequate risk management may also affect change management. For example, the impact of an IT system planned outage (e.g. scheduled downtime) may not be fully appreciated with systems in current commercial use, and a planned outage may have consequences that may be unpredictable. Current user acceptance tests (UATs) may be poorly designed, for example being either too narrow or broad. Testing may not address all applications or contingencies and, conversely, testing of applications not impacted by a change may add needless test costs. Often, change management teams may not have confirmation for operation of an untested application until after a change goes live.

Incident management, further, may not provide the benefit of risk management. Incident management processes execute typically after the occurrence of an incident (e.g. after a system crash, slow down, etc.). However, information to resolve incidents may be collected in some systems, for example, during escalation and evaluation phases occurring prior to an incident. With currently available systems, data to identify the dependencies of a customer's or client's processes (e.g. dependencies on IT supplier infrastructure or a customer's internal IT infrastructure) may not be available.

For such issues, an embodiment of the present invention may provide efficiencies and benefits to enterprises accessing or providing elements of an IT infrastructure system.

### Risk Modeling

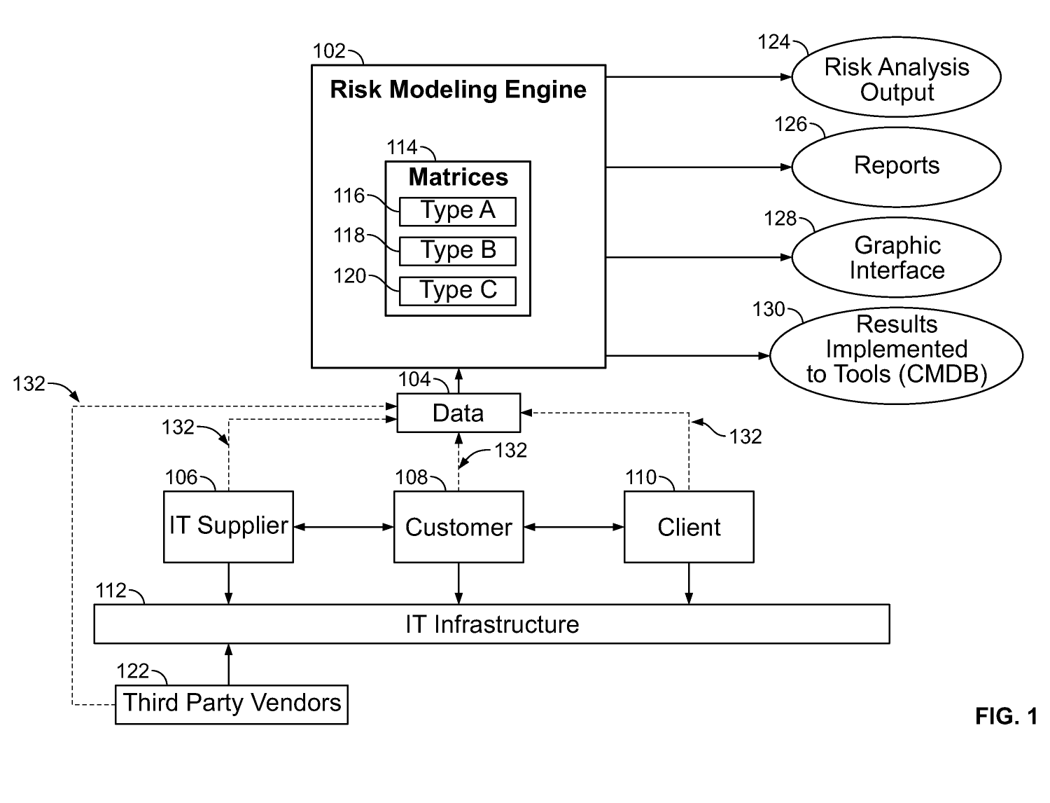

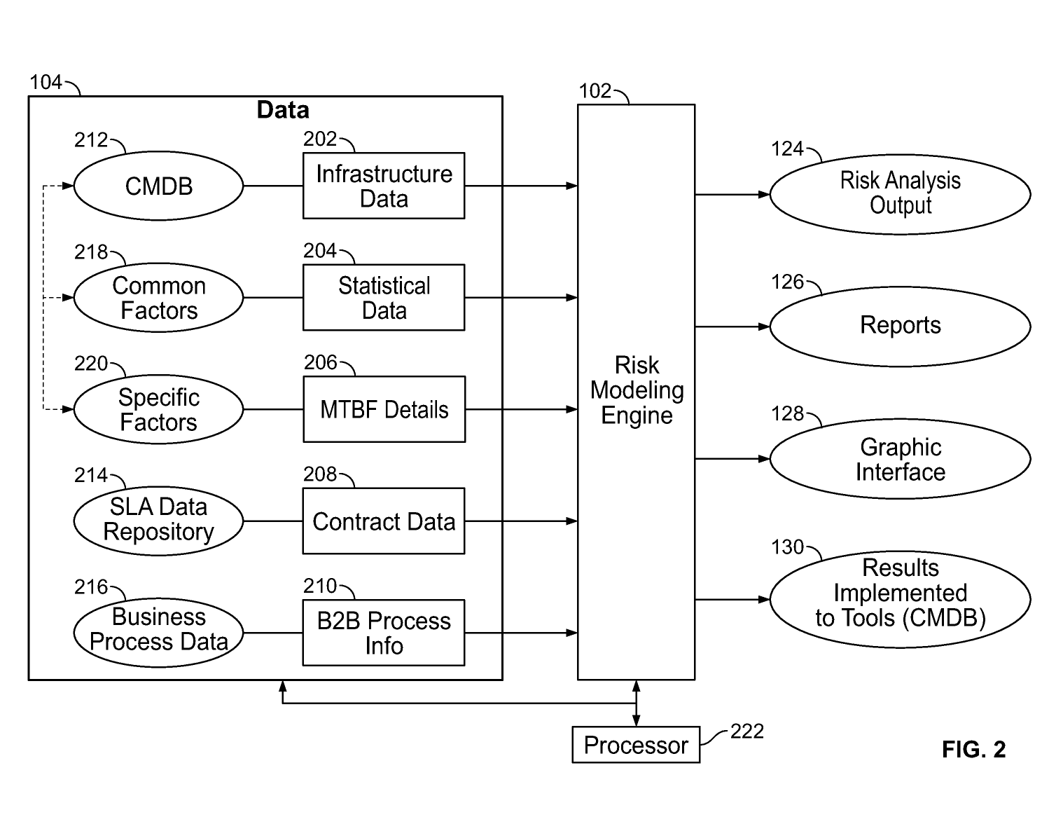

Reference is now made to FIG. 1, which depicts a system for identifying, analyzing and managing risks to enterprises accessing or providing IT infrastructure, according to an embodiment of the present invention. Risk modeling engine 102 in FIG. 1 receives data 104 (e.g. from CMDB, SLA, business process, common factors and specific factors repositories (see FIG. 2)). Data 104 may be received from sources (collectively identified by dashed lines 132), such as sources maintained or gathered from IT supplier 106, customer 108, client 110 and/or third party vendors 122. Risk modeling engine 102 may identify and analyze risks concerning enterprises (e.g. IT supplier 106, customer 108 and client 110) that use or provide elements of IT infrastructure system 112.

In providing identification, analysis and management information for IT-related risk to the enterprises, risk modeling engine 102 may generate matrices 114, to map relationship dependencies between the processes of the enterprises and the underlying elements of IT infrastructure 112.

As noted above, in an example where the enterprises are IT supplier 106, customer 108 and client 110, risk management engine 102 may generate:

Matrix 116, type A, (e.g. which may map IT supplier 106's infrastructure elements and services to customer 108's internal IT and support processes;

Matrix 118, type B, (e.g. which may map customer 108's business processes to IT infrastructure 112 elements (for example, elements provided by IT supplier 106 or the customer's own internal IT departments); and

Matrix 120, type C, where business processes of a customer's client 110, such as business-to-business (B2B) processes, may be mapped (e.g. through dependency relationships), for example, to customer enterprise processes such as customer IT systems, customer finance, customer manufacturing, etc.

In addition, interdependencies may be considered by risk modeling engine 102 with regard to third party vendors 122 of IT systems, services or equipment. For example, through additional dependency relationships risk modeling engine 102 may consider the impact of third-party vendors 122 that may provide IT-related services, as contracted for by IT supplier 106, customer 108 or client 110.

Using data 104, risk modeling engine 102 may execute a risk analysis, where risk analysis outcomes 124 may include as stated:

Identification of a level of protection a business process or IT infrastructure element may require based upon the process or element's determined business criticality and value, where risk assessment values (e.g. risk factor values, and criticality values) may be provided;

Identification of the IT infrastructure (and design) used by or relied upon by a business process being analyzed (including, for example, any manual processes connecting or impacting the IT infrastructure system or business processes);

Evaluation of potential and/or possible IT infrastructure system failures that may impinge on the performance of the business process or related IT infrastructure elements;

Identification and implementation of possible proactive measures to take, recovery strategies and alternatives (for example, by providing recommendations for changes to IT infrastructure, applications, and system design, providing recommendations for recovery strategies);

Recommendations on alternatives—(for example recommendations for new or revised terms in IT infrastructure-related agreements such as service-level agreements (SLAs), recommendations for client contract negotiations (B2B2C) (e.g. between a customer and client) and, support of IT incident-, problem-, and/or change-management functions; and

Financial data (e.g. financial analysis) which may assist an enterprise (e.g. 106, 108 and 110) in selecting, for example, an appropriate level of investment into the infrastructure for business protection.

Reports 126 may be generated from the risk modeling engine 102 regarding infrastructure business processing reliability, economic impact statements, etc. and may be made available to each enterprise involved (e.g. IT supplier 106, customer 108 and client 110) in hardcopy or electronic form. Electronic reports may be made available, for example, through graphic interface 128.

After analysis, risk modeling engine 102 may further provide results 130 that may be implemented uploaded to tools or data repositories such as those within a configuration management database (CMDB).

### Data Environment

FIG. 2 illustrates a data environment for a risk modeling engine, such as risk modeling engine 102, in accordance with an embodiment of the invention. The data environment includes input data factors 202, 204, 206, 208, 210 processed by risk modeling engine 102 (from data sources 212, 214, 216, 218, 220 of data 104), and output results 124, 126, 128, 130 provided by risk modeling engine 102. Risk modeling engine 102, for example may be executed by processor 222 and in executing risk modeling engine 102, processor 222 may access data 104 (and data sources 212, 214, 216, 218, 220).

CMDB 212 may include information on the hardware, firewall, router and operating system/applications of the IT infrastructure. Data factor 202 may be provided by CMDB 212 to risk modeling engine 102. A CMDB may be an information repository housing data related to components of an IT information system. A CMDB may be maintained, for example, by the IT supplier, the customer and/or the third party vendor. A CMDB, for example, may be compliant with the guidelines and practices set out in Information Technology Infrastructure Library (ITIL) guidelines and may represent the authorized configuration of the significant components of IT infrastructure system.

Information provided by data factor 202 may include infrastructure data, such as for example, a description of system configuration, equipment, operational statistics, historical performance, number of users, load information, etc. This information may be analyzed and/or correlated by risk modeling engine 102 for use in developing the failure prediction statistics for the IT infrastructure. For example, the number of users, the degree of automation (number of failovers, redundant systems present), the number of outages, the number of open and closed problem or incident tickets, and the number of changes may be an indication of, or have a direct impact on, the stability of the system.

Data factor 202 may further include asset data (e.g. general and specific information on infrastructure equipment), configuration data, latest change information, and/or the latest configuration of a CMDB item. Data factor 202 (from CMDB 212) may also include statistical data on assets, the number of external customers related to a CMDB item and/or service; the number of customers using the service of a particular CMDB item; the number of changes per interval of time (hour, day, week, month, etc) for a particular CMDB item and/or service; number of active users, the level of automation (number of failovers, redundant systems present); the historic number of outages; the number of change windows; the number of outages per level of severity (e.g. outages, system impact); history of outage duration; complexity of system configuration. Data factor 212 may also include reliability statistics on infrastructure hardware and/or software components of the CMDB (e.g. mean-time-between-failure (MTBF), mean-time-to-repair (MTTR), mean-time-to-failure (MTTF)); firewall information including the number of firewall rules (the greater the number, the more impact they may have); router information including number of routing protocols used by the system (the greater the number, the more impact they may have); and/or information on the operating system and applications including the number of patches implemented in a period of time (the greater the number, the more impact they may have—a large number of patches may indicate an unstable software system). It is noted here that information from CMDB may also be used for common factors and specific factors data repositories 218, 220 (also described below). Descriptions of the common and specific factors may be used to evaluate risk for specific risk matrix types. In one example, data for the common and specific factor repositories 218, 220 comes from CMDB 212, but in other examples, the data may also come from other sources. For example MTTR and MTTF data may come from CMDB 212, but it also may be provided by a manufacturer for a specific infrastructure component. Depending on the circumstance, infrastructure data 202, may be split and used also as “common factors” and “specific factors” data e.g. 204, 206.

From SLA data repository 214, data factor 208 may include contract data, such as for example, elements of service level agreement (SLA) terms and conditions, such as contract data, availability, business processes, criticality, revenue lost per unit of time (e.g. minute/hour/day), and/or dependencies between individual or groupings of business processes.

Business process data repository 216 may provide information for data factor 210, which may include business-to-business process information regarding suppliers, sales, parts, credits, etc. Information of this nature may be analyzed by risk modeling engine 102 to predict and/or evaluate the impact of a customer's clients (e.g. 110) business on the IT infrastructure (e.g. 112) provided by IT supplier 110 and/or customer 108.

Common factors data repository 218 may provide information for data factor 204, which may include statistical data for common features of the IT infrastructure system (e.g. 112). Specific factors data repository 220 may provide information for data factor 206, which may include statistical data on specific elements of the IT infrastructure system 112, such as MTBF data collected for specific elements. As stated above, common factors data repository 218 and specific factors data repository 220 may be constructed from, for example, information from CMDB 212, where repositories 218, 220 may be built for evaluating risks for specific a risk matrix type (e.g. a risk matrix of type A, B or C 116, 118, 120).

Using the data (e.g. data factors 202, 204, 206, 208, 210), risk modeling engine 102 may a produce risk analysis outputs 124 (e.g. generating proactive measures, financial data, SLA terms/analysis values (risk factor and criticality values), etc.). Based on the risk analysis, risk modeling engine 102 may also generate reports 126, which for example, may be transmitted to the users (e.g. IT supplier 106, customer 108 and/or client 110 via a graphic interface 128). Additionally, risk modeling engine 102 may further provide risk data infrastructure result information that may be uploaded to tools or data repositories, e.g. CMDB (e.g. 212, FIG. 2) associated with a type of risk matrix in question.

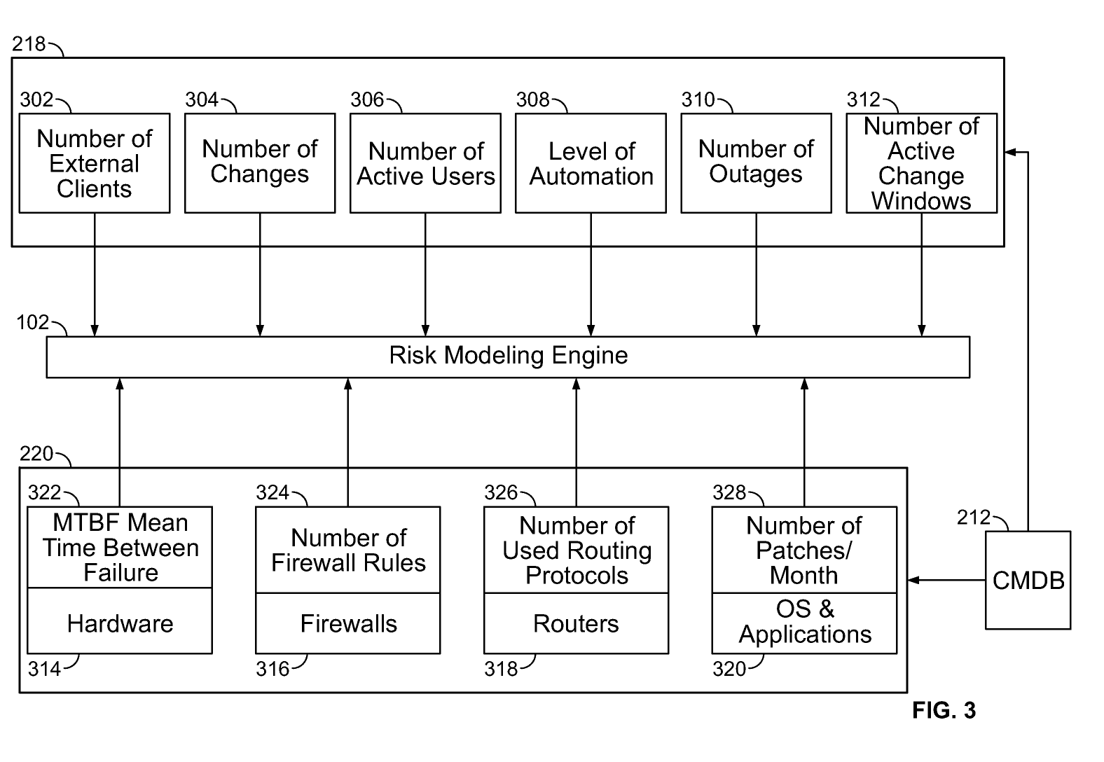

Reference is now made to FIG. 3, which illustrates representative data inputs for common factors data repository 218 and specific factors data repository 220 in accordance with an embodiment of the invention. For example, common factors data repository 218 may include statistical data concerning, for example skill set levels of employees, complexity of configurations etc. As shown in FIG. 3, statistical data may include information such as: the number of external clients and/or customers using an IT infrastructure element 302, the number of changes/modifications that have been made to an IT infrastructure element 304, the number of active users of an IT infrastructure element 306, the level of automation 308 (the number of failovers (e.g. depth of switching to redundant system(s))), the number of outages for the IT infrastructure element 310, and the number of change windows that may be available 312 (e.g. for maintenance and upgrade). Data from common factors data repository 218, may have been built, e.g. using data from CMDB 212, and common factors data repository 218 may be used for analysis of any IT infrastructure element and, for example, may be used for analyzing relationships (e.g. dependencies) in one of the risk matrices (e.g. 116, 118, 120, FIG. 1). Common factors data repository 218 may also be applicable to and usable for all of the risk matrices 116, 118, 120 and those matrices may each incorporate common system elements.

Specific factors data repository 220 may provide information concerning specific IT elements, such as hardware 314, firewalls 316, routers 318 and operating systems and applications 320. For example, for hardware elements 314, the specific factors data repository 220 may provide information such as MTTF, MTTR and MTBF information 322 for each element, where this data may have been obtained from CMDB 212. For each firewall 316, specific factors data repository 220 may provide, for example, information concerning the number of firewall rules that have been established 324. For each router 318, specific factors data repository 220 may provide, for example, information concerning the number of routing protocols used by each router 326. For operating systems and applications 320, specific factors data repository 220 may provide, for example, information concerning the number of software patches that are applied to each system element per month 328. Other common and specific data concerning IT infrastructure elements may also be provided.

### Matrices

A risk modeling engine, such as risk modeling engine 102, may provide evaluations and predictions regarding the sustainability of the IT infrastructure, software and/or applications. As stated, in performing risk analysis, risk modeling engine 102 may generate a risk matrix to perform such analysis.

Reference is now made to FIG. 4, which illustrates three risk matrixes 460, 470, 480 in accordance with an embodiment of the invention. Risk matrixes 460, 470, 480 may be contingent on the reliability, availability, interdependency, and continued operation of various IT infrastructure and/or application components, e.g. in an example involving an IT supplier, customer, client (and, additionally, third-party vendors). Risk matrices 460, 470, 480 may be similar to matrices 116, 118, 120 shown in FIG. 1.

As shown in FIG. 4, IT supplier 410 may provide supplier infrastructure elements 411 to customer 420 (e.g. through a connections to customer's internal IT infrastructure 422 and/or customer's enterprise processes 423. Supplier infrastructure elements 411 may include services 412 (e.g. network services, mail services, desktop services, hosting services etc.), applications 414, and other IT infrastructure hardware and/or software items 416. Customer 420 may have its own internal IT infrastructure 422 (e.g. local servers, modems, routers, switches, user terminals, etc.) and its own enterprise processes 423 including customer IT processes 424 (e.g. sales processes 426, IT contract processes 428 and ITIL processes 430) and customer business processes 432 (e.g. finance processes 434, manufacturing processes 436 and HR processes 438.

IT supplier 410's infrastructure elements 411 may be mapped (for example, in matrix 460) to customer's 420 internal IT processes 422 (e.g. indicating that IT supplier's infrastructure elements support customer's internal IT processes). IT supplier 410's infrastructure elements 411 may also be mapped (e.g. in matrix 470) to customer's enterprise processes 423 (e.g. customer IT processes 424 (sales 426, IT contract 428, ITIL 430) and customer business processes 432 (finance 434, manufacture 436, HR 438)).

Customer 420 may have one or more clients 440 having business processes 442 (e.g. sales 444, parts and accessories 446, and credits 448, for a sales business, such as automobile sales). Vendors and other third parties 450 may also provide infrastructure, support, applications and other related services to IT supplier 410, customer 420, and/or clients 440.

Risk matrix 460 (e.g. type-A) may map IT supplier 410's infrastructure elements and services to customer 420's internal IT and support processes and may be contingent on the continued support and services provided by IT supplier 410 to customer 420.

Risk matrix 470 (e.g. type-B) may map (e.g. through dependency relationships) customer's enterprise processes 423 to IT supplier's (410) infrastructure elements 411 and/or to customer's own internal IT elements 422. Dependencies in matrix type-B 470 may be contingent on the continued well being of the components and applications of risk matrix type-A (460) plus the continued operation and interaction of customer internal IT 422 and enterprise processes 423 (including e.g. 424, 432).

Risk matrix 480 (e.g. type-C) may be contingent on the proceeding two risk matrixes (risk matrix type-A 460 and risk matrix type-B 470) plus the continued operation and interaction of client 440's business processes 442. The IT infrastructure and business processes of risk matrix type-C 480 may show business to business (B2B) processes of the client, and map them to elements of the IT infrastructure. It should be noted that client 440 need not be a B2B provider, and that any other business or system is equally applicable to the invention.

Systems and methods in accordance with an embodiment of the invention may evaluate the internal and external operation and interaction of the various components of the systems and applications for the IT supplier, customer, and/or customer's clients to determine any potential and/or possible enterprise IT failures that may cause system operation to slowdown, and/or suspend operation (e.g. crash). One result of this evaluation may be a chart or report that may provide failure prediction statistics for the individual components. In one example, the evaluation may include predictions on the ripple effect a failure of a particular, and/or group of, component(s) may have on the operation and interaction of the various components of the IT supplier, customer, and/or customer's clients.

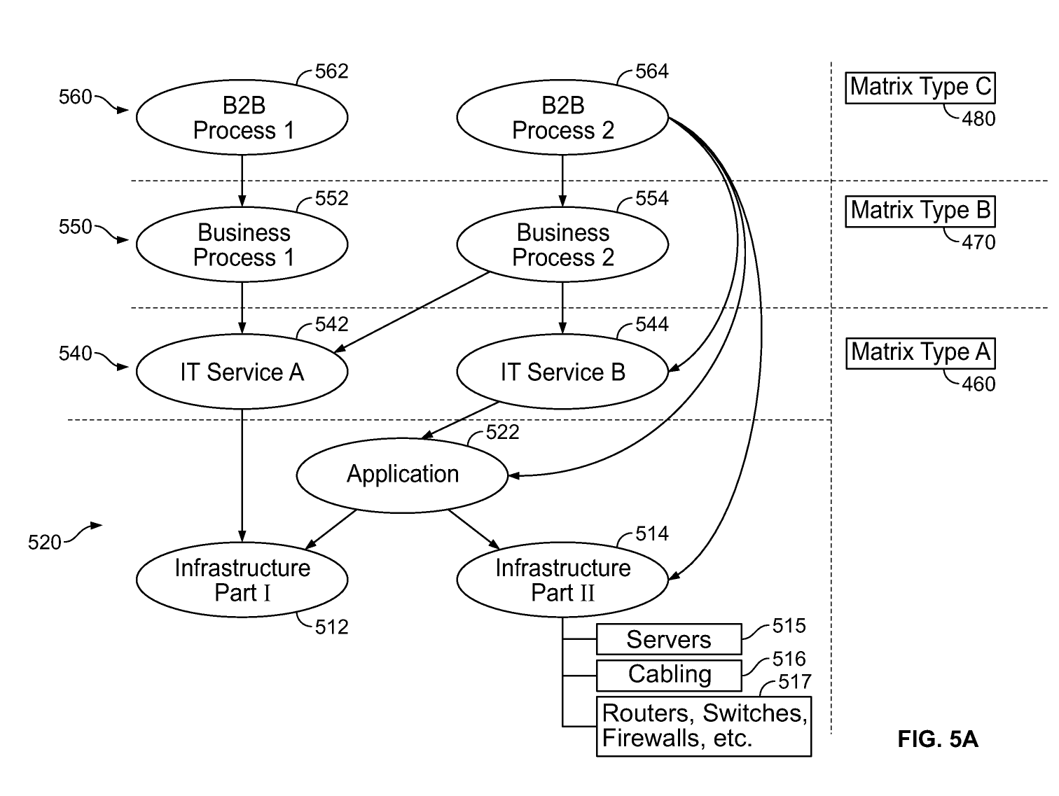

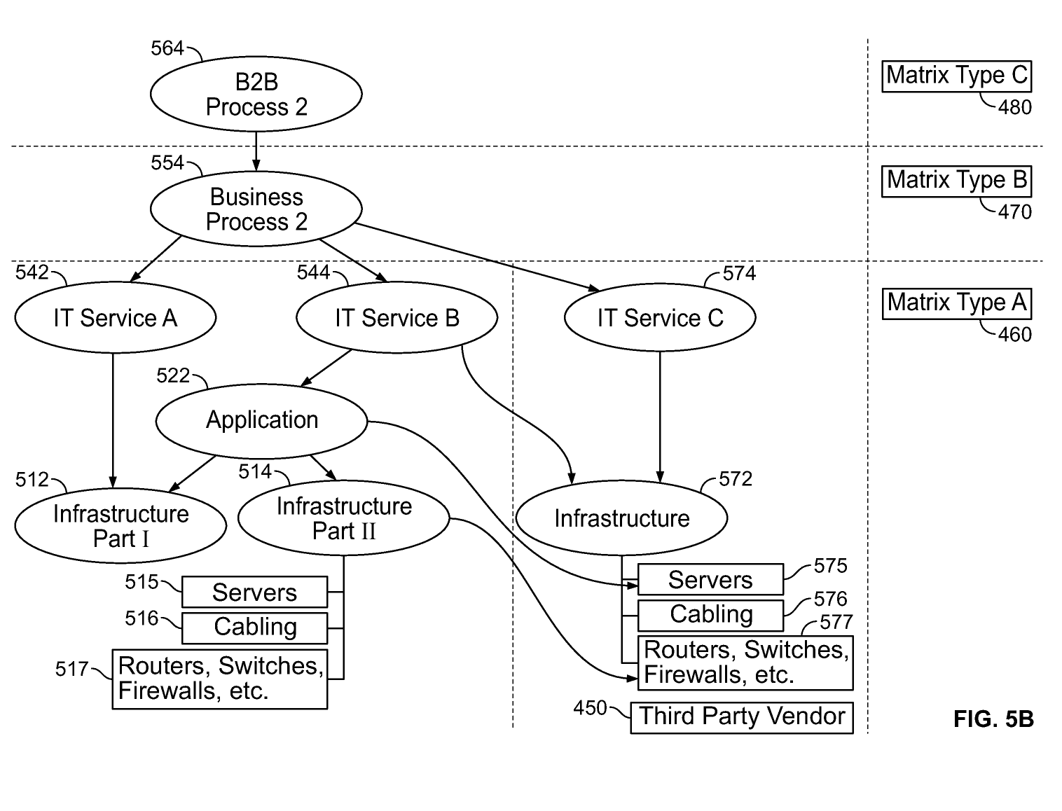

FIG. 5A illustrates the dependencies and/or interdependencies that may be considered by a risk modeling engine, such as risk modeling engine 102, with regard to individual risk matrixes 460, 470, 480 in accordance with an embodiment of the invention. For example, with regard to risk matrix type-C 480, B2B processes 560 may include B2B first process 562 and B2B second process 564. B2B first process 562 and B2B second process 564, for example, may be processes of customer 420 which may support business processes of customer's client 440 B2B processes 562, 564 may define one or more requirements for first business process 552 and second business process 554 (e.g. IT, finance, manufacturing, sales etc.) of business processes 550.

Definitions for first business process 552 and second business process 554 (e.g. of customer 420) may impact the nature of risk matrix type-B 470. Business processes 550 may define one or more of the requirements of IT elements 540 provided by IT supplier 410 (see, IT infrastructure elements 411). The definition by business processes 550 of IT service A 542 and IT service B 544 may impact the nature of risk matrix type-A 460.

IT services 540 may define (or link to) one or more requirements and/or factors that may affect an application layer (520), e.g. of risk matrix A 460, which may include one or more application(s) 522, and IT infrastructures 512, 514 (application(s) 522 may also contribute to the definition of IT infrastructures 512, 514). A minimum requirement here may be the mapping of the Applications and Infrastructure components (522, 512, 514) to the IT Services (542, 544) supported by them. One goal of the Matrix A may be to evaluate the risks of the provided IT Services 540. With this, 540 and 520 may be part of Matrix Type A 460.

B2B first process 562 and B2B second process 564 may be supported by elements of the IT infrastructure of customer's client (e.g. 440). B2B processes 562, 564 may include, for example, sales, parts and accounts receivable, accounts payable, credits, etc. (442, FIG. 4). The dependencies and/or interdependencies of B2B process 562, 564 may impact risk matrix type-C 480.

First business process 552 and second business process 554 may be supported, for example, by customer internal IT elements (e.g. 424, FIG. 4) and/or by services contracted from IT supplier 410 (e.g. IT infrastructure elements 411, FIG. 4). Customer IT processes 424 (e.g. including processes like sales 426, IT Contract 428 and ITIL 430, etc.) may also support. The dependencies and/or interdependencies of these B2B process (on the customer-side) may impact risk matrix type-B 470.

IT service A 542 and IT service B 544 may be IT services offered by IT supplier 410 to customer 420. Other IT infrastructure elements provided by IT supplier 410, can be business processes which are used to fulfill the customer's requirements. These IT services could be network services, server hosting, management processes (e.g. multi-vendor coordination, etc.), change management, problem management, etc. The definition of IT service A 542 and IT service B 544 may impact the nature of risk matrix type-A 460.

In accordance with an embodiment of the invention, application(s) 522 may also have an impact on risk matrix-A 460. Application(s) 522 may support the needs of both customer 420 and customer's clients 440. Application(s) 522 may be provided by IT supplier 410 to support the customer's and the customer's client's business processes, and may include mail systems, databases, etc.

IT infrastructures 512, 514 may be the physical components that host business processes (and applications) and deliver services to the customer. IT infrastructure 514, for example, may include servers 515, cabling 516, routers, switches, firewalls, etc. 517.

In accordance with an embodiment of the invention, the dependencies and interdependencies of the various IT infrastructure, processes, and applications illustrated in FIG. 5A may have a ripple effect on each other. For example, B2B processes 562, 564 (of customer's client 440) may map to components that could impact overall service directly. For example, B2B second process 564 may have a dependency and/or interdependency with second business process 554. In this example, second business process 554 may be a service or a contract between customer 420 and customer's client 440 that supports B2B second process 564.

In turn, for this example, IT service A 542 and IT service B 544 may be provided to customer 420 by IT supplier 410 in support of customer's business process 554 (e.g. where IT service B 544 is used most directly to support B2B second process 564). Application(s) 522 may be provided by IT supplier 410 to customer 420 in support of IT services B 544. Further, IT infrastructure 512 and 514 (e.g. including components 515, 516, 517) may be used to support application(s) 522. IT infrastructure 512 may also support IT service A 542.

In such an example, dependencies and interdependencies between IT infrastructure elements and the processes of the customer and client may be seen. For example, B2B process 564 may be directly reliant on business process 554 and indirectly reliant on IT service A 542, IT service B 544, application(s) 522, IT infrastructure 512, IT infrastructure 514, server 515, cabling 516, and routers, switches, firewalls, etc. 517 (as indicated by representative curved lines from 564 to 514, 522 and 544 in FIG. 5A).

By evaluating and analyzing these dependencies and interdependencies, in accordance with an embodiment of the invention, a risk modeling engine, such as risk modeling engine 102, may assess the risk potential to each owner and/or user (e.g. IT supplier 410, customer 420, and customer's client 440) of the infrastructure and/or business process. Additionally, in the event of an incident, risk modeling engine 102, may inform impacted parties.

Referring again to FIG. 5A, for example, a failure may occur to IT infrastructures 512, 514. Should IT infrastructures 512, 514 both be impacted by a failure, there may be redundancies (back up modules and/or replacement services) available for IT infrastructures 512 and 514 (redundancies not shown in FIG. 5A). If redundant IT infrastructures exist, there may be no impact on the IT infrastructure system and no impact to the functioning of processes at 520, 540, 550 and 560 (e.g. Application(s) 522, IT services 542, 544, business processes 552, 554 and B2B processes 562, 564). However, there may be a greater risk after the failure than before, because one back up source may now have been used up (so a failure even with redundancies may increase risk). Such an increase in risk may be recognized by risk modeling engine 102, and may be accounted for in its risk assessment outputs (e.g. risk analysis outputs 124, reports 126, and results uploaded to tools and data repositories, e.g. CMDB 130, FIGS. 1, 2).

In the event of failure by IT infrastructures 512, 514 where there are no redundancies (so, for example, an actual service outage occurs), the affect of a failure can be shown on the processes that depend upon the failed element. FIG. 5A illustrates, for example, that application(s) 522, IT services 542, 544, customer processes 552, 554 and B2B processes 562, 564 are reliant (through dependencies and interdependencies) on IT infrastructure 512 (and a failure of that infrastructure element will affect performance of all of those elements). In accordance with an embodiment of the invention, risk modeling engine 102 may inform the involved/impacted parties, for example, so that disaster recovery processes may be implemented.

Reference is now made to FIG. 5B, which illustrates, in accordance with an embodiment of the invention, dependencies and/or interdependencies that may be considered by a risk modeling engine, such as risk modeling engine 102, when a third party vendor, such as third party vendor 450, may be delivering IT infrastructure elements. In FIG. 5B, third party vendor 450 may provide IT infrastructure 572, which may include servers 575, cabling 576, routers, switches, firewalls, etc. 577. Third party vendor 450 may also provide IT service C 574, which may be supported with applications (not shown).

As illustrated in FIG. 5B, dependencies and/or interdependencies may exist between IT infrastructure 572, components 575, 576, 577, and/or IT service C 574 and other infrastructure, services and applications (e.g. such as those discussed above with reference to FIG. 5A). For example, B2B process 564 may be dependent upon customer process 554. Customer process 554 may have dependencies to IT service A 542, IT service B 544 and also IT service C 574 (provided by third party vendor 450).

Further dependencies may exist. For example, IT service A 542 may be dependent on IT infrastructure 512. IT service B 544 may be dependent on application(s) 522. Application(s) 522 may depend upon IT infrastructure 512 and IT infrastructure 514 (which may include server 515, cabling 516 and routers, switches, firewalls, etc. 517). IT service C 574 may depend upon IT infrastructure 572 (from third party vendor 450) and hardware such as servers 575, cabling 576 and routers, switches, firewalls, etc. 577.

Additional dependencies or interdependencies may be identified between infrastructure elements provided by third party vendor 450. For example it is possible that customer 420 may have a contract with IT supplier 410 and third party vendor 450. IT supplier 410 may be responsible for e.g. mailing services. In this example, IT supplier 410 may be responsible for maintaining an OS (e.g. like infrastructure 514) and a mailing application (like application 522). Third party vendor 450 may responsible for infrastructure components like servers (e.g. 575) and network (e.g. 577, routers, switches, firewalls, etc.) which are used or relied upon by IT supplier for infrastructure 514.

If an Infrastructure component of third party vendor 450 fails (such as for example 575, 577), the failure may have a direct impact on the IT service B 544, business process 2 (customer process 554) and B2B process 564. If server 575 (of third party vendor 450) fails, or if a component of server 575 has an error, the failure may also lead to a failure of application 522 (or the related OS) maintained by IT supplier 410. The result is the same as if third party vendor 450 performed a change on the server 575. If server 575 is changed, application 522 may be impacted directly and with this all other parts of the system such as 544, 554, 564.

Additionally, it may be seen from FIG. 5B that an outage to cabling 576 or routers, etc. 577 of third party vendor 450 may also impact the operation of IT supplier's Infrastructure 514. In such an example, IT supplier 410 may be responsible to operate server(s) 515 to provide IT service B 544 to customer 420. Third party vendor 450 may be responsible for a Wide Area Network (WAN) or for a Local Area Network (LAN). If a network component (e.g. 576, 577) of third party vendor 450 fails, the failure may have a direct impact on Infrastructure 514 from IT supplier 410 (e.g. a DB connection failure may lead to a corrupt data set or the hanging of an application that cannot connect to server 515 or send or receive needed data).

In accordance with an embodiment of the invention, risk modeling engine 102 may evaluate, analyze, and/or correlate the dependencies and or interdependencies introduced into the IT infrastructure by third party vendor 450 in developing the failure prediction statistics. Risk modeling engine 102 may evaluate, analyze, and/or correlate aspects associated with the overall IT infrastructure and its applications, for example, managing changes and preparing for changes to the IT infrastructure, any service level agreements, firewall management, etc. Changes to the IT infrastructure and its application (e.g. as a result of infrastructure 572 and IT service C 574) may have an impact on a customer 420 and/or customer's client 440. IT supplier 410 may provide definitions of the level of testing and information as input to risk modeling engine 102.

Risk modeling engine 102, for example using the dependencies in matrices 460, 470, 480 above, may define appropriate service terms for an SLA for customer 420. Often a higher level of service may be contracted for than may be needed in an SLA, based on the production processes involved. For example, from a business perspective it may be unimportant if an email service for an employee is unavailable for a timeframe of 10 hours (e.g. during transatlantic flights). However, if the email service is used for order submission and entry, its failure, for any time length at all, may be critical from a business perspective. As another example, an outage (e.g. of more than two hours) of a production control system can endanger the whole business of the customer and such a risk of outage may be considered an important, or critical risk factor.

In another example of possible analysis that may be provided by a risk modeling engine in accordance with an embodiment of the present invention, risk modeling engine 102 may need to assess the impact of a shared firewall. For example, a shared customer firewall system may host multiple customers (e.g. 420). In one example, a firewall system could host more than 100 customers. Each customer may have a different service level and different change management processes including varying change windows. In such an example, it may become impossible for IT supplier 410 to schedule the same change window for maintenance upgrades for the customers. Risk in firewall maintenance may then be assessed as very high, because a patch or update of hardware or software may not be possible to easily install. Shared firewall rules, in such situations, may add a further risk, because, for example, removing a shared firewall rule for service associated with customer A, could impact the shared firewall service level for customer B. By providing risk modeling engine 102 with this information, a more accurate risk analysis may be generated.

### Reports

In accordance with an embodiment of the invention, a risk modeling engine, such as risk modeling engine 102, may provide reports 126 (FIGS. 1, 2). Reports 126 may include presentation of results regarding infrastructure, business processing, reliability, economic impact statements, etc. Reports 126, for example may be made available to each of IT supplier 410 customer 420, and/or customer's clients 440 (FIG. 4, and see also 106, 108, 110 FIG. 1). Reports 126 may be provided electronically over an electronic communication network, or may be displayed via graphical interface 128 (FIGS. 1, 2) on one or more display devices local to the report recipients. In one implementation, a hardcopy of reports 126 may be generated either automatically or at the request of a report recipient.

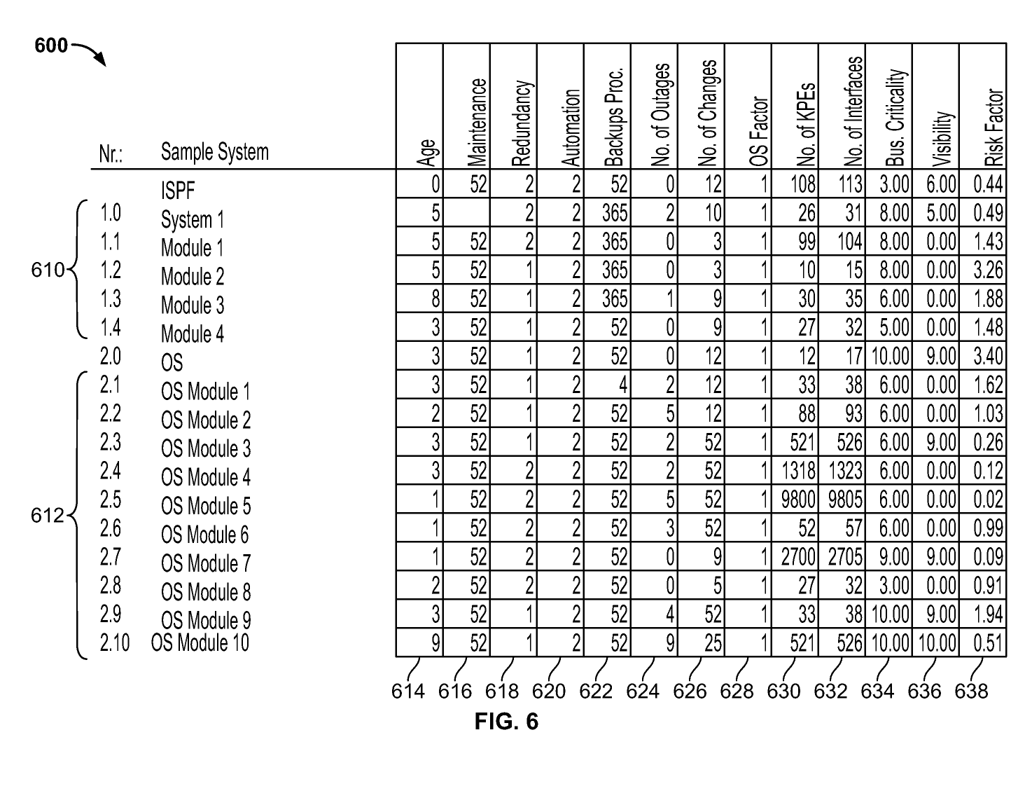

FIG. 6 illustrates report 600 in accordance with an embodiment of the invention. Report 600 may be the result of risk modeling engine 102's analysis of a representative IT infrastructure having any interactive system productivity facility and running in a multiple access or virtual environment independent on provided operating system. Report 600 may be an example of reports 126.

Report 600 may have multiple columns 614-638 that provide information either used by risk modeling engine 102 and/or generated as output by risk modeling engine 102. For example, age column 614 may indicate the age (years and/or months) of a particular IT infrastructure component. Maintenance column 616 may indicate the frequency (per period of time e.g. per month/year) of maintenance conducted on a particular component. Redundancy column 618 may indicate the number of back-up units, systems, and/or applications are resident in the IT infrastructure for a particular component. Automation 620 may provide a factor which can be used to evaluate risk. For example, if a process (e.g. failover process, software update process etc.) is automated, then in analysis risk contributed by the process may be reduced (e.g. by a factor of 2 (as is shown in column 620) or by another factor that may be defined). Backup procedure column 622 may indicate the frequency (per period of time) that software, applications, and/or data is backed up. The number of outages column 624 may indicate frequency of outages (per period of time). The number of changes column 626 may indicate the frequency of changes (per period of time e.g. per month/year). OS factor column 628 may indicate a flag to show if a component is related to the OS or not in the software classification list. Column 630 may indicate the number of Key Production Environments (KPEs), which are dependent on a particular module (e.g. to send or receive data). For example, if a particular module triggers 1,200 production-relevant printers, the risk rating of this module may be influenced by the number of dependent KPEs (i.e., 1,200). The number of interfaces column 632 may indicate a quantity of interfaces (hardware or software) that a component may use.

In accordance with an embodiment of the invention, each of these factors (and others) may be used by risk modeling engine 102 in determining the reliability and/or sustainability of the IT infrastructure. Business criticality column 634 may be an example of one factor generated by risk modeling engine 102. With this factor, the customer/client may rate his/her own business process according to a scale (e.g. from 1 (low importance) to 10 (high critical)). The use of this factor may allow a user-defined criticality of a process to be brought into a risk evaluation. Risk modeling engine 102 may map, based on the matrixes, this criticality value from a business process to its corresponding components. Business criticality may measure the impact the failure of a component may have to the operation of the business' IT infrastructure undergoing analysis. Visibility column 636 may indicate the visibility to the client a failure may have. For example, a failure to deliver print services may be fully visible to the client. (Mail system issues may also be fully visible to a customer and/or client). The VIP status of a service (e.g. a special status for services like PDA (Blackberry) service or other priorities) even if not being production relevant, may be also considered in visibility analysis. In an embodiment in accordance with the invention, risk modeling engine 102 may provide data as presented in risk factor column 638. A risk factor value may be presented for each component. In other implementations, a risk factor may be generated on other levels of granularity—e.g. subcomponent, system, subsystem levels, etc.

Risk factor column 638 shows, for example, that component System 1 (1.0) may have a risk factor of 0.49 (e.g. out of for example a range from 0 to 5, where for example 0 equals no risk and 5 equals high risk) and that component Module 2 (1.2) may have a risk factor of 3.26. A component with a higher risk factor may indicate that the IT infrastructure (or portion thereof) could be at a greater risk of failure should that component cease normal functioning and/or operation. Information presented in report 600 may be used in determining where further redundancies, failovers, maintenance, etc. may be needed to render a particular IT infrastructure more stable, sustainable, and reliable.

### Risk Modeling Engine

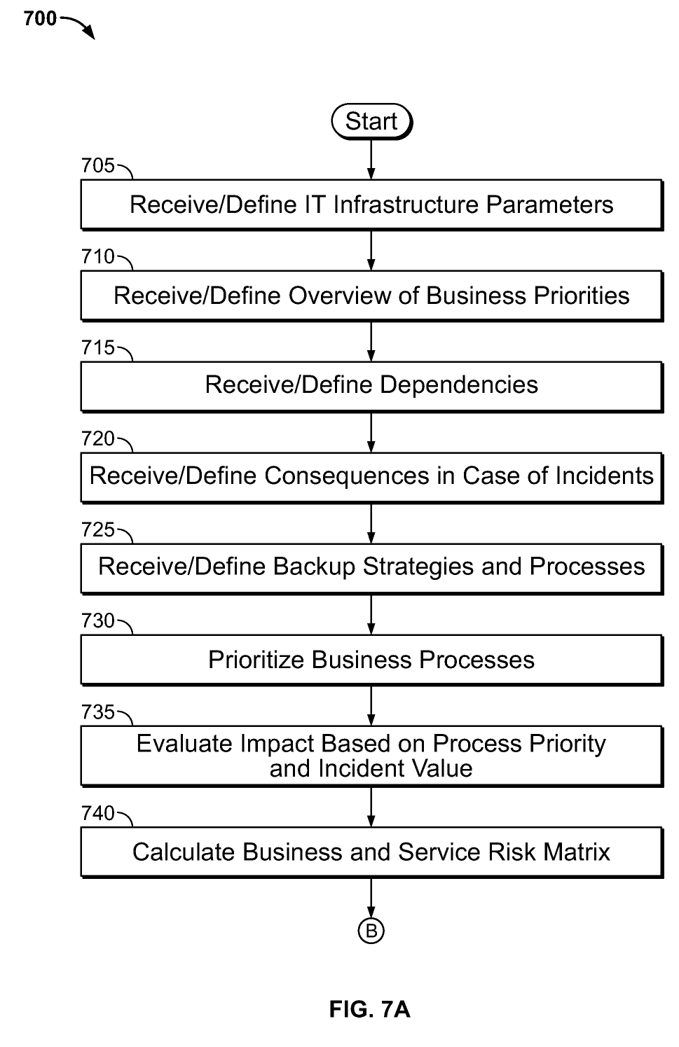

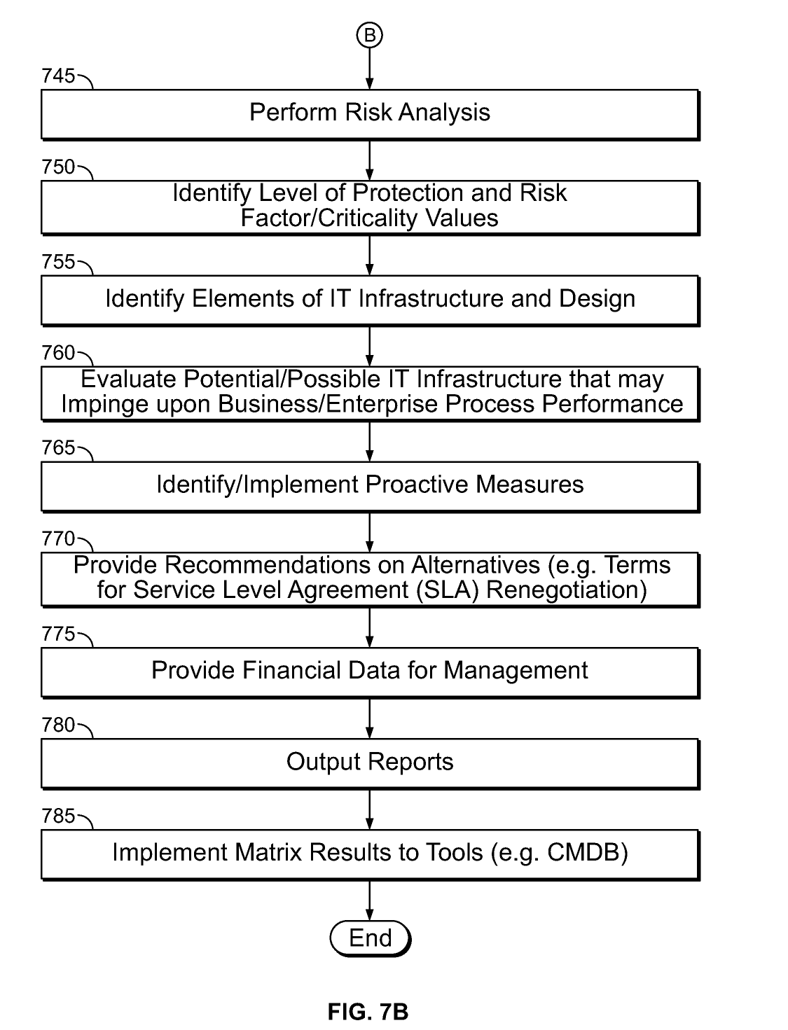

FIGS. 7A-7B illustrates process 700 in accordance with an embodiment of the invention. Referring now to FIG. 7A, process 700 may operate within a risk modeling engine, such as risk modeling engine 102 (for example executed by processor 222), to achieve the risk assessments described above. In accordance with an embodiment of the invention, process 700 may obtain, by receiving and/or defining, (in step 705) parameters specifying the particular IT infrastructure to undergo risk analysis. Parameters may be obtained from, for example, data sources (such as CMDB 212, SLA data repository 214, business process data 216, common factors 218 and specific factors 220, FIG. 2).

At step 710, process 700 may receive definitions that define an overview of the business priorities important to the operators and/or users of the IT infrastructure. These definitions may be based, for example, on content of an SLA (e.g. which may be stored in SLA data repository 214) or business process data (e.g. 216) additionally, business priorities may be specified from sources outside of the data repositories, such as from system architects and corporate managers (e.g. a chief information officer (CIO) or manager).

Definitions of the dependencies among the IT infrastructure elements (and enterprise/business processes of the customer and client) may be obtained, defined and/or received at step 715. Examples of such dependency definitions can be seen in FIGS. 5A, 5B. Process step 715 operates to map the dependencies between the different business processes. Many business processes supported by IT, generally have dependencies between each other. Step 715 may allow description of those processes that have some dependency to other processes. For example, if Business Process 1 has a direct impact on Business Process 2, the requirements for Business Process 2 may be updated to reflect the dependency on the impact of Business Process 1. The results of the assessment for the risk matrix may be stored into a business process data repository (e.g. 216). This data may be used, for example, to evaluate the risk for the business processes as supported by the IT services.

Consequences of potential incidents may be obtained, defined and/or received (in step 720) by process 700 from one or more data stores (e.g. CMDB 212), users, and/or system administrators. Process step 720 may define in general what may happen with the business in the case of an IT failure and may provide information such as: What are the costs of a possible incident based on money/hour loss. Such cost data may have a direct influence of the result of the risk matrix analysis. Consequence data, additionally, may be used in reports, such as for example, in reports for the management of an IT supplier or customer. Consequence data may be also used to map costs to different IT parts/items in the CMDB, so that possible financial loss is documented in the CMDB, addition to the parts/items' links to specific business processes.

Backup strategies, processes, redundancies may be obtained, defined and/or received in step 725 (e.g. from sources such as a system administrator). The identification and assessment of available backup strategies and processes can increase or decrease the business risks for the customer.

Process 700 may prioritize, in step 730, business priorities. In one implementation data concerning business priorities may be received by process 700—e.g. from the SLA (e.g. as part of SLA data repository 214) business process data repository 216, the client and/or user, or the system administrator.

Process 700 may evaluate, in step 735 impact on business, outage, financial, the impact of possible and/or potential failures of IT infrastructure in combination with the aforementioned definitions. This evaluation may be based on business process priorities and/or incident value. In step 740, business and service risk matrix (matrices) may be calculated (e.g. by risk modeling engine 102). In an example with an IT supplier (106, 410), customer (108, 420) and client (110, 440), process 700 may in step 770 generate risk matrices, such as matrices of type A, B and C (116, 118, 120, FIGS. 1, and 460, 470, 480, FIG. 4). For example, process 700, may generate (using a computer processor e.g. 222), a plurality of matrices, where, for example, an IT infrastructure element supplied by an IT supplier may be mapped to an internal IT support element of a customer, an external process of the customer may be mapped to the IT infrastructure element (and, additionally, to an internal IT support element of the customer), and a business process of a client of the customer may be mapped to the external process of the customer. The process may further continue with reference now to FIG. 7B.

In accordance with an embodiment of the invention, process 700 may, in step 745 (FIG. 7B) perform a risk analysis, for example to generate outputs (e.g. where such a process may be executed by risk modeling engine 102 operated by a computer processor (e.g. 222). For example, in step 750, process 700 may identify risk assessment values for components, subsystems and systems (e.g. where risk factor values, and criticality values may be provided) and identify a level of protection for a business process or IT infrastructure element based upon the process or element's determined business criticality and value.

In step 755, process 700 may identify elements of the IT infrastructure (and design) used to implement the business process being analyzed (including, for example, any manual processes connecting or impacting either the IT infrastructure system or business process using the IT infrastructure system). In step 760, process 700 may provide an evaluation of potential and/or possible IT infrastructure system failures that may impinge on the performance of the business process or related IT infrastructure elements. The evaluation may be included as risk analysis output 124 and incorporated, for example, into reports 126.

Additionally, in step 765, process 700 may identify and implement proactive measures to reduce the risk associated with the current implementation of the business process in the present IT infrastructure system (for example, by providing recommendations for changes to IT infrastructure, applications, and system design, providing recommendations for recovery strategies). Such recommendations for changes may be included as risk analysis output 124 (and incorporated into reports 126). Additionally, proactive measures and recommendations may be incorporated into terms which may then be stored a service-level agreement SLA data repository (e.g. 214). If, for example, a risk of business process failure is found to be higher than expected or currently defined, then it may be possible that a customer and IT supplier may need to change one or more key production indicators (KPIs) that have been defined in the service level agreement (SLA) that is currently in force between them. For example, if, in a service level agreement, a business process has an defined recovery time of 5 hours and the business risk for this process found to be very high (because the potential loss for the client is so very high for each hour in case of incident), then the 5 hour recovery time term may have to be renegotiated between the IT Supplier and Customer. Because the risk to the client is so high in this example, the KPI may have to be changed, for example, from 5 hours to 1 hour or more less.

In step 770, process 700 may further provide recommendations on alternatives—(for example recommendations for new or revised terms in IT infrastructure-related agreements, such as service-level agreement (SLA), recommendations for client contract negotiations (B2B2C) (e.g. between a customer and client) and, support of IT incident-, problem-, and/or change-management functions. Such recommendations on alternatives may be also included as risk analysis output 124, incorporated into reports 126 and incorporated into terms which may then be stored in a SLA repository 214. In step 775, process 700 may provide financial data concerning IT infrastructure system elements, for example, for use as selection criteria in determining an appropriate level of investment into additional and/or upgraded IT infrastructure. The financial data may be included as risk analysis output 124 and incorporated into reports 126.

In step 780, process 700 may generate/output reports (e.g. 126, FIGS. 1, 2), which may be distributed, for example, to an IT supplier, customer and/or client (e.g. 106, 108, 110, FIGS. 1 and 410, 420, 440, FIG. 4) either in hardcopy form or on a display (e.g. via a graphic user interface such as 128, FIGS. 1, 2). Reports generated in step 780 may have a form as shown in FIG. 6 and may display criticality and risk factor values.

In step 785, process 700 may further generate data (result information) that may be uploaded to tools or data repositories, e.g. CMDB (212, FIG. 2) associated with a type of risk matrix question (see, also 130, FIGS. 1, 2). This implementation may result in changes to parameters of the information system for the IT infrastructure. For example the results of the business matrix analysis, like risk factors 638 may be documented to different configuration items in CMDB 212 in accordance with the risk of their supported services. For resources shared by environments the highest risk factor may define the risk for a component.

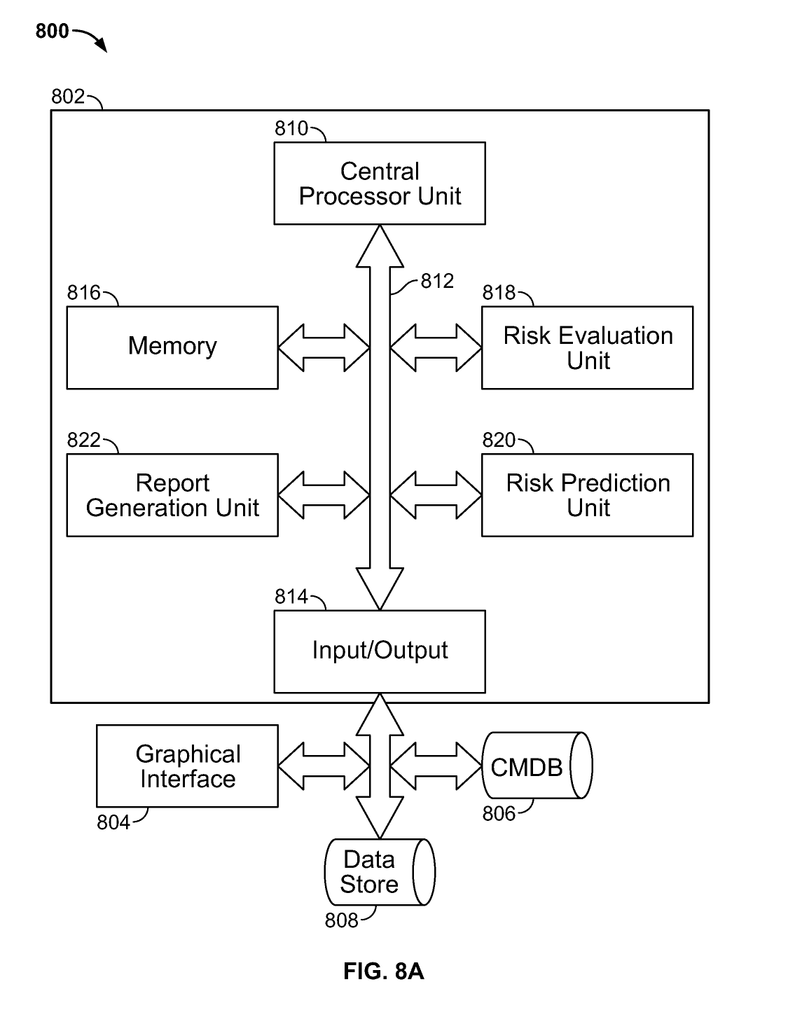

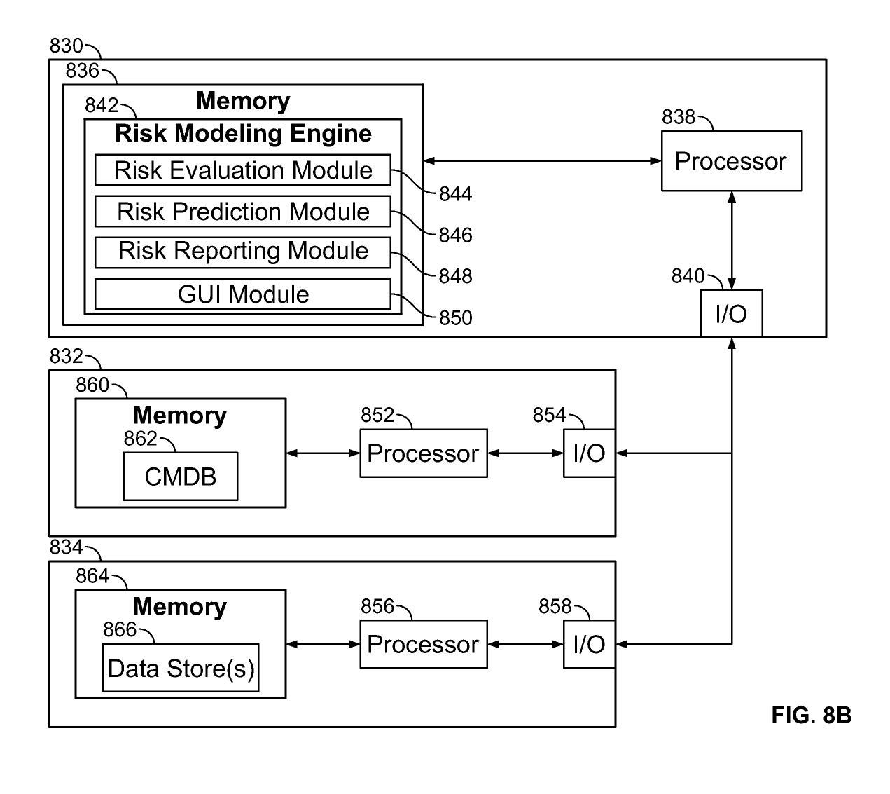

FIG. 8A illustrates system 800 in accordance with an embodiment of the invention. System 800 may include risk modeling engine 802, graphical interface 804, CMDB 806, and data store(s) 808. Graphical interface 804 may present and/or display, to a user which may be a system administrator (e.g. of an IT supplier, customer or client), one or more reports generated by risk modeling engine 802. CMDB 806 (e.g. like CMDB 212, FIG. 2) may include information on the hardware, firewall, router and operating system/applications of the IT infrastructure. Data store(s) 808 may include data, such as that found in SLA data repository 214, business process data repository 216, common factors data repository 218, and/or specific factors data repository 220 (in FIG. 2). In one implementation each of these data repositories may be in a single data store, or may be in individual data stores (not shown).

Risk modeling engine 802 may include controller or processor (CPU) 810, internal bus 812 (or other processor connection), input/output port 814, memory 816, risk evaluation unit 818, risk prediction unit 820, and report generation unit 822. CPU 810 may execute computer instructions stored in internal memory 816 to control risk evaluation unit 818, risk prediction unit 820, and report generation unit 822 so that a risk analysis of a modeled IT infrastructure may be performed. The executable instructions may be loaded in internal memory 816 from a computer readable medium connectable to system 800. Internal memory 816 may have capacity to store data locally (i.e., internally) to risk modeling engine 810 to facilitate processing speed. In one implementation, risk modeling engine 802 may read input data from CMDB 806 and data store(s) 808 during execution of instructions.

Risk evaluation unit 818 may evaluate the impact that may occur to the IT infrastructure based on one or more risk factors described above. This evaluation may include technology and innovation risk, operational risk, political/regulatory risk, process risk, and/or human/organizational risk. Business criticality may be an example of one factor generated by risk evaluation unit 818.

Risk prediction unit 820 may calculate the risk tolerance of the IT infrastructure as a whole system, collection of individual subsystems, components, subcomponents, and/or application(s). The risk tolerance may be expressed as a numeric, decimal number.

In accordance with an embodiment of the invention, risk evaluation unit 818 and risk prediction unit 820 may be incorporated into a single operational unit.

Report generation unit 822 may generate a report (e.g. 600, FIG. 6) that can include both input data to risk modeling engine 802 and the results of risk evaluation unit 818 and risk prediction unit 820. Report generation unit may further generate outputs (such as terms for SLA agreements and other risk analysis outputs 124, FIG. 2, and results for implementation (uploading) at a CMDB 130, FIG. 2).

Reference is now made to FIG. 8B, which depicts another example of a system for risk analysis and management in accordance with an embodiment of the present invention. FIG. 8B depicts a distributed system of computers 830, 832, 834. Computer 830 includes memory 836, processor 838 and I/O unit 840. Memory 836 includes programming modules (in software) for risk modeling engine 842, including a risk evaluation module 844, risk prediction module 846, risk reporting module 848 and graphic user interface module(s) 850. Each of the modules 844, 846, 848, 850, when executed by processor 838, may perform, for example, the processes described in FIGS. 7A-7B and also may perform functions similar to risk evaluation unit 818, risk prediction unit 820 report generation unit 822 and graphical interface 804, which are shown in FIG. 8A. Memory 836 may include for example, server storage (from which each of the modules 844, 846, 848, 850 of risk modeling engine 842 may be downloaded and installed (e.g. to memory of processor 838, such as RAM memory)), portable memory such as compact disk (CD) memory and/or DVD memory and system memory, such as a hard drive or solid state drive (SSD) on which modules 844, 846, 848, 850 may already be installed.

Computers 832, 834, in FIG. 8B may be coupled to computer 830. Processor 852 of computer 832 may communicate with processor 838, through I/O unit connections 854, 840. Processor 856 of computer 834 may communicate with processor 838 through I/O unit connections 858, 840. Processors 852, 856 may provide data to processor 838, for its use in operating the software modules (844, 846, 848, 850) of risk modeling engine 842.

Memory 860 of computer 832 may include CMDB 862. CMDB 862 may contain configuration and other information concerning IT infrastructure elements (similar to CMDB 212, FIG. 2). Processor 852 may provide CMDB data (from 862) to processor 838. Memory 864 of computer 834 may include data store(s) 866. Data store(s) 866 may include data repositories, such as the SLA data, business process data common factors and specific factors repositories 214, 216, 218 and 220 of FIG. 2. Processor 856 may provide data from data store(s) 866 to processor 838. Memories 860 and 864 may also include for example, server storage from which information from CMDB 862 and data store(s) 866 may be downloaded and read. Memories 860 and 864 may further include portable memory, such as compact disk (CD) memory and/or DVD memory, and system memory, such as a hard drive or solid state drive (SSD) on which CMDB 862 and data store(s) 866 files may already be installed.

### Information Aggregation

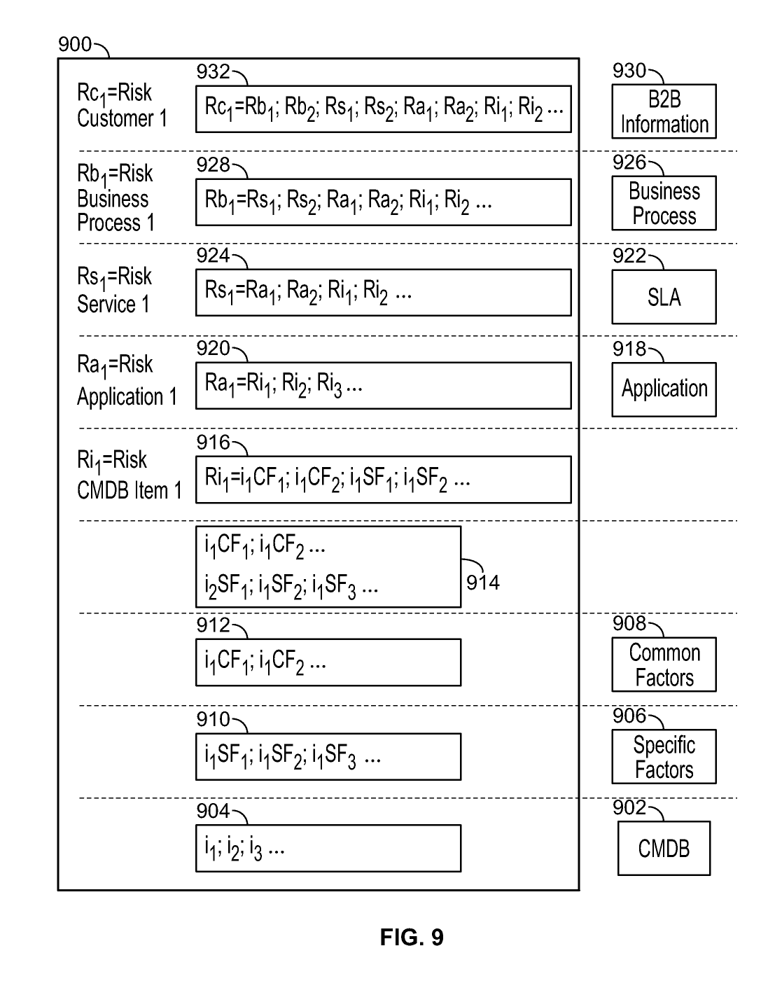

Reference is now made to FIG. 9, which illustrates information aggregation 900 in accordance with an embodiment of the invention which may be occur, for example during a risk analysis (e.g. step 745, FIG. 7B). Information aggregation 900 depicts that IT infrastructure risks may be cumulative. For example, CMDB 902 may have information elements i₁, i₂, i₃, . . . (e.g. configuration items) 904. Each of information elements 904 may be combined with data found in data repositories, e.g. specific factor repository (SF₁, SF₂, . . . ) 906, common factor repository (CF₁, CF₂, . . . ) 908, etc. Specific factor repository 906 may provide data (SF₁, SF₂, . . . ), which may result series (i₁SF₁, i₂SF₂, . . . ) 910. Common factor repository 910 may provide data (CF₁, CF₂, . . . ), which may result in series (i₁CF₁, i₂CF₂, . . . ) 912. This data may yield cumulative series (i₁CF₁; i₁CF₂; . . . ), (i₁SF₁; i₁SF₂; . . . ), etc. 914.

For each cumulative series generated, a risk may be formulated (based on an information element, and respective factors)—e.g. risk for CMDB item 1 may be expressed as Ri₁=i₁CF₁; i₁CF₂; . . . ; i₁SF₁; i₁SF₂; . . . ; . . . 916. A cumulative risk for an application (e.g. 918) that may use the information from the CMDB (or may be otherwise reliant on CMDB item 1) may be expressed as Ra₁=Ri₁; Ri₂; Ri₃; . . . 920. The risk for a service level agreement (e.g. 922) providing application 918 may be expressed as an aggregation represented by Rs₁=Ra₁; Ra₂; Ri₁; Ri₂; . . . 924. The risk for a business process (e.g. 926) reliant on terms from service level agreement 922 may be expressed as an aggregation represented by Rb₁=Rs₁; Rs₂; Ra₁; Ra₂; Ri₁; Ri₂; . . . 928. The risk for a customer utilizing business process (e.g. 930 (B2B information)) may be expressed as an aggregation represented by Rc₁=Rb₁; Rb₂; Rs₁; Rs₂; Ra₁; Ra₂; Ri₁; Ri₂; . . . 932. As shown in FIG. 9, the aggregation of risk may increase as the extent of the IT infrastructure extends.

An embodiment of the invention, may provide a non-transitory computer-readable medium having stored thereon instructions (e.g. in the form of a computer program application) which when executed by a processor cause the processor to perform a method such as the method of performing risk analysis and management as described herein (see, e.g. FIGS. 7A-7B).

A computer program application stored in non-volatile memory or computer-readable medium (e.g. register memory, processor cache, RAM, ROM, hard drive, flash memory, CD ROM, magnetic media, etc.) may include code or executable instructions that when executed may instruct or cause a controller or processor to perform methods discussed herein such as a method of identifying the level of protection business processes and assets (e.g. IT infrastructure) require based upon their business criticality and value, and identifying the IT infrastructure and design used to implement these business processes. The non-volatile memory and/or computer-readable medium may be a non-transitory computer-readable media including all forms and types of memory and all computer-readable media except for a transitory, propagating signal.

### Additional Considerations

Unless specifically stated otherwise, as apparent from the discussions herein, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored as instructions or code in an article such as a memory device, where such instructions upon execution by a processor or computer result in the execution of a method of an embodiment of the invention.

While there have been shown and described fundamental novel features of the invention as applied to several embodiments, it will be understood that various omissions, substitutions, and changes in the form, detail, and operation of the illustrated embodiments may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A non-transitory computer readable medium having stored thereon instructions, which when executed by a processor cause the processor to perform the method of:
generating a plurality of risk matrices, wherein an external process of a customer of an IT supplier is mapped to an IT infrastructure element of the IT supplier and a business process of a client of the customer is mapped to the external process of the customer;
performing a risk analysis using the plurality of matrices to determine a criticality value for the IT infrastructure element in relation to the business process; and
causing a presentation of the criticality value.

2. The non-transitory computer readable medium of claim 1, wherein generating a plurality of matrices comprises:
generating a first matrix, wherein the IT infrastructure element is mapped to an internal IT support element of the customer;
generating a second matrix, wherein the external process of the customer is mapped to the IT infrastructure element and to the internal IT support element of the customer; and
a third matrix, wherein the business process of the client is mapped to the external process of the customer.

3. The non-transitory computer readable medium of claim 2, wherein a dependency relationship is used to perform at least one mapping.

4. The non-transitory computer readable medium of claim 2, said method further comprising:
generating contingencies between the first, second and third matrices such that:
the first matrix is contingent upon the continued operation of the IT infrastructure element supplied by an IT supplier;
the second risk matrix is contingent on the continued operation of the IT infrastructure element plus the continued operation of the internal IT support element of the customer; and
the third risk matrix is contingent on the first and second matrices and the continued operation of the business process of the client.

5. The non-transitory computer readable medium of claim 1, wherein the criticality value is a business criticality value measuring the impact the failure of a component may have to the operation of the IT infrastructure system.

6. The non-transitory computer readable medium of claim 1, comprising determining from the risk analysis a term for use in one of negotiating or renegotiating a service level agreement.

7. The non-transitory computer readable medium of claim 1, comprising calculating based on the risk analysis, a risk tolerance of the IT infrastructure system.

8. The non-transitory computer readable medium of claim 7, wherein the risk tolerance is calculated for at least one of a whole system, one or more subsystems, one or more components, one or more subcomponents, and one or more applications.

9. A system for modeling risk factors for elements of an information technology (IT) system, the system comprising a memory and a processor configured to execute program instructions stored in the memory, the memory storing program instructions that when executed by the processor function as a risk modeling engine configured to:
generate, using data from a configuration management database (CMDB), a risk matrix, wherein, an external process of a customer of an IT supplier is mapped to an IT infrastructure element of the IT supplier;
perform a risk analysis, to determine a criticality value for IT infrastructure element in relation to a business process of a client of the customer; and
cause a presentation of the criticality value

10. The system of claim 9, wherein the CMDB is used for management operations in the IT infrastructure system.

11. The system of claim 10, wherein the CMDB is used for management operations according to ITIL guidelines.

12. The system of claim 10, wherein the risk modeling engine generates a result from the risk analysis that may be implemented in a tool of the configuration management database (CMDB).

13. The system of claim 9, the risk matrix being generated also using data from a service level agreement repository.

14. The system of claim 9, the risk matrix being generated also using data from a business process data repository.

15. The system of claim 9, the risk matrix being generated also using data from a common factors data repository.

16. The system of claim 9, the risk matrix being generated also using data from a specific factors data repository.

17. The system of claim 9, the risk management engine further is configured to map, by a dependency relationship an IT infrastructure element of a third party vendor to the external process of the customer.

18. A method for modeling risk factors for elements of an information technology (IT) system, the method comprising:
generating, using a computer processor, a plurality of risk matrices, wherein an external process of a customer of an IT supplier is mapped to an IT infrastructure element of the IT supplier and a business process of a client of the customer is mapped to the external process of the customer;
performing, using the computer processor, a risk analysis using the plurality of matrices to determine a criticality value for the IT infrastructure element in relation to the business process; and
causing a presentation of the criticality value.

19. The method of claim 18, wherein the criticality value is determined based on an assessment of risk for one of a technology and innovation risk, an operational risk, a political/regulatory risk, a process risks or human resource/organizational risk.

20. The method of claim 18, further comprising:
performing said risk analysis using definitions for business priorities based content from a service level agreement.
